(19) United States
(12) Patent Application Publication
(10) Pub. No.: US 2017/0255957 A1
(43) Pub. Date: Sep. 7, 2017

(54) METHOD AND SYSTEM FOR PROVIDING, TRACKING AND REDEEMING VIRTUAL MOBILE COUPONS

(71) Applicants: Vikram Mehta, Cupertino, CA (US); Ravi Kant Bhatt, Cupertino, CA (US)

(72) Inventors: Vikram Mehta, Cupertino, CA (US); Ravi Kant Bhatt, Cupertino, CA (US)

(21) Appl. No.: 15/062,186

(22) Filed: Mar. 6, 2016

(51) Int. Cl. G06Q 30/02; G06Q 20/20; G06Q 20/32; G06Q 50/00

(52) U.S. Cl. CPC G06Q 30/0224; G06Q 50/01; G06Q 30/0226; G06Q 20/204; G06Q 20/3278

(57) ABSTRACT

A method and system is provided for generating, distributing, tracking, managing and redeeming electronic coupons. The system includes a coupon service that generates and distributes electronic coupons to users using mobile devices. The coupon service also tracks the redemption of the electronic coupons. Further, a user may redeem an electronic coupon using a mobile device and may also share the electronic coupons with other users.

### FIELD OF THE INVENTION

The present invention disclosure relates to electronic coupons and more specifically, to using a mobile device to receive and redeem the electronic coupons.

### BACKGROUND OF THE INVENTION

Distributing discount coupons and other similar offers to potential customers has been an effective marketing strategy to increase the sale of products and services. Traditionally, coupons have been distributed in form to print coupons to customers through mail, newspapers, magazines, handouts and flyers. With the Internet becoming a commonly accessible technology, coupons are being shared with customers through electronic mediums such as emails, websites dedicated to coupon distribution and websites owned by merchants and manufacturers. Coupons are a great incentive to attract new customers and retain the existing customers.

There are various channels for tracking and distributing electronic coupons. For example, there are coupon aggregator websites that offer print and electronic coupons from several merchants and manufacturers. A customer looking for discount offers/deals visits such websites to gain access to coupons to be redeemed on merchant websites or stores. Typically, any customer can use the coupons provided by such websites. The customer may redeem a selected coupon by entering a coupon code on merchant website or presenting a printed copy of the coupon at a merchant store. Also, the customer may download the coupon on his mobile phone and present it at merchant store for redemption. Some coupon aggregator websites also redirect the customer to the merchant website and the selected coupon is redeemed automatically.

In another example, merchants offer coupons and deals to target a specific set of customers through their websites, online advertisements and emails. Some merchants have membership based reward programs and thus, maintain a profile for every customer who is a member. This enables the merchant to generate personalized coupons based on customer profiles and track the expiry and redemption of coupons.

In yet another example, there are local coupon provider websites that have prior agreements with merchants to provide discount coupons/deals. Examples of such websites are Groupon® and LivingSocial® etc. A customer visits such a website and pre-pays for a merchant's product to purchase a coupon/deal. Typically, a customer may redeem the coupon at the merchant store by presenting a printed copy of the coupon or by presenting the coupon downloaded on his mobile phone.

### BRIEF DESCRIPTION OF THE DRAWINGS

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an exemplary system 100 for generating, distributing, managing, tracking and redeeming virtual mobile coupons according to an embodiment of the invention.

FIG. 2 illustrates a server 110 for generating, managing and redeeming virtual mobile coupons according to an exemplary embodiment of the invention.

FIG. 3 illustrates a wireless device 115 for managing and redeeming virtual mobile coupons according to an embodiment of the invention.

FIG. 4 illustrates a method 400 for redeeming virtual mobile coupons according to an embodiment of the invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DESCRIPTION

Before describing in detail the particular method and a system for providing, tracking and redeeming virtual coupons, in accordance with various embodiments of the present invention, it should be observed that the present invention resides primarily in the method and system for providing, tracking and redeeming virtual coupons. In this document, the terms “comprises,” “comprising,” or any other variation thereof, are intended to cover a non-exclusive inclusion, such that a process, method, article or apparatus that comprises a list of elements does not include only those elements, but may include other elements that are not expressly listed or inherent in such a process, method, article or apparatus. An element proceeded by “comprises . . . a” does not, without more constraints, preclude the existence of additional identical elements in the process, method, article or apparatus that comprises the element.

The term “another,” as used in this document, is defined as at least a second or more. The terms “includes” and/or “having,” as used herein, are defined as comprising. The term “program,” as used herein, is defined as a sequence of instructions designed for execution on a specialized computer system. A “program,” or “computer program,” may include a subroutine, a function, a procedure, an object method, an object implementation, an executable application, an applet, a servlet, a source code, an object code, a shared library/dynamic load library and/or other sequence of instructions designed for execution on a specialized computer system.

In an embodiment, the invention describes a system and method for generating, managing and redeeming a plurality of virtual mobile coupons.

The system comprises a processor, which is operatively coupled to a storage unit. The processor consists of a coupon generation unit, a distribution unit and a tracking unit. The coupon generation unit generates a plurality of virtual mobile coupons based on a set of coupon parameters provided by a registered client. The registered client is a merchant or a manufacturer. Each virtual mobile coupon is associated with a unique user identifier. The distribution unit distributes virtual mobile coupons amongst one or more users. Further, the distribution unit is configured to distribute virtual mobile coupons based on pre-determined criteria. For example, a first user of the one or more users receives the virtual mobile coupon using a wireless device. The first user redistributes the virtual mobile coupon to a second user using the wireless device. The tracking unit is configured to track the redistribution and redemption of the virtual mobile coupons. As the virtual mobile coupon is redistributed by the first user to the second user, the tracking unit records a unique user identifier of the second user.

The storage unit, which is operatively coupled to processor, is configured to store a coupon metadata for the virtual mobile coupon. The coupon metadata generated by the processor comprises the set of coupon parameters and the unique user identifier associated the virtual mobile coupon. The storage unit also stores the redemption status for the virtual mobile coupon.

In an embodiment, the registered client uses a coupon upload interface to provide the set of coupon parameters.

In an embodiment, the coupon generation unit is further configured to generate a level two virtual mobile coupon when a level one virtual mobile coupon is redistributed by the first user to the second user. The second user belongs to a trusted social network of the first user.

In an embodiment, the tracking unit is further configured to track redistribution of the virtual mobile coupon.

In an embodiment, the predetermined criteria for the distribution of virtual mobile coupons is selected from the list comprising location of the user, a purchase history of the user, a redemption history of the user, a profile associated with the user and a social activity of the user, and user targeting parameters provided by the registered client.

In an embodiment, the system further comprises a reward unit configured to award reward points to the first user based on a rewarding criteria, wherein the rewarding criteria is determined based on at least one of number of times the virtual coupon is redistributed, number of times the virtual mobile coupon is redeemed, visits to redemption stores by at least one of the first user and the second user.

In an embodiment, the redemption record of the virtual mobile coupon comprises at least one of a unique user identifier, a timestamp, an identifier of a Point-of-Sale (POS), a merchant identifier and a manufacturer identifier.

In an embodiment, the invention provides a wireless device for managing and redeeming virtual mobile coupons. The wireless device comprises a registration unit, a transceiver, a redistribution unit, a mobile tracking unit, a radio interface unit, and a processor. The registration unit is configured to register a user with a coupon service. The transceiver is configured to receive a plurality of virtual mobile coupons from the coupon service. The plurality of virtual mobile coupons are stored in a memory unit. The redistribution unit is configured to redistribute a virtual mobile coupon of the plurality of virtual mobile coupons. The mobile tracking unit is configured to detect a merchant site. The wireless device detects the merchant site when the wireless device is proximate to a point-of-sale (POS). The radio interface unit is configured to communicate with the POS, wherein the radio interface unit receives product information from the POS. The processor is configured to identify one or more virtual mobile coupons of the plurality of virtual mobile coupons. The one or more virtual mobile coupons are redeemable at the POS. A radio interface unit further configured to automatically send the one or more virtual mobile coupons to the POS, wherein the one or more virtual mobile coupons are sent to the POS for redemption.

In an embodiment, the radio interface unit is a Near Field Communication (NFC) interface.

In an embodiment, the redistribution unit is further configured to define a set of rules for automatically redistributing the virtual mobile coupon.

In an embodiment, the processor is further configured to set priorities among the plurality of virtual mobile coupons based on a pre-determined priority criteria.

In an embodiment, the processor is further configured to generate a Quick Response Code (QR code) for the virtual mobile coupon.

In an embodiment, the mobile tracking unit is further configured to record at least one of from the group comprising purchase history of the user, redemption history of the user, and visits to one or more merchant sites by the user

The invention further relates to a non-transitory computer-readable medium storing instructions for providing a coupon management system. The instructions are executed on the processor to cause the processor to receive a plurality of virtual mobile coupons, store the plurality of virtual mobile coupons in a memory unit, detect a merchant site using a mobile tracking unit, identify one or more virtual mobile coupons of the plurality of virtual mobile coupons that are redeemable at a POS and automatically send one or more virtual mobile coupons to the POS using a radio interface unit for redemption.

In an embodiment, the processor receives product information through the radio interface unit from the POS.

In an embodiment, the processor enables a user to manually select one or more virtual mobile coupons to be sent to the POS for redemption.

In an embodiment, the processor receives a redemption status from the POS.

While various embodiments are disclosed, still variations of the embodiments of the present invention will become apparent to those skilled in the art from the following detailed description, which describes illustrative embodiments of the invention, or may be learned by practicing the invention as set forth hereinafter. As will be realized, the invention is capable of modifications in various aspects, all without departing from the scope of the present invention. Accordingly, the drawings and detailed description of the present invention are to be regarded as illustrative in nature and not restrictive.

Certain portions of this application, such as the Abstract and Summary, are provided to allow the reader to quickly ascertain the nature of the disclosure. They are submitted with the understanding that they will not be used to interpret or limit the scope or meaning of the claim.

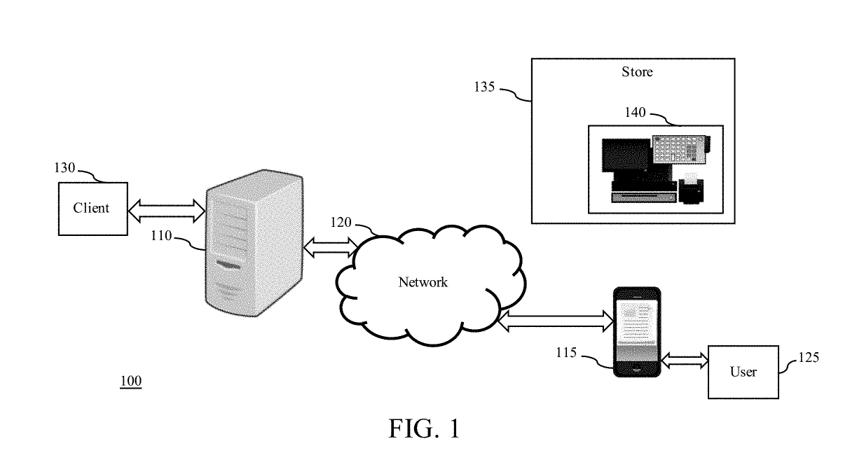

FIG. 1 illustrates an exemplary system 100 according to an embodiment of the present invention. The system 100 includes a server 110 that is connected to one or more wireless devices, for example to a wireless device 115, through a network 120. Examples of the network 120 include, but are not limited to, a mobile telecommunication network, a Wi-Fi network, a Bluetooth network, a local area network (LAN), a Wide area network (WAN), and the Internet. Examples of the wireless device 115 include, but are not limited to, a mobile phone, a laptop, a tablet and a Personal Digital Assistant (PDA).

In an embodiment, the server 110 runs a coupon service and thereby, generates virtual mobile coupons and distributes the virtual mobile coupons to users, for example to a user 125 of the wireless device 115 based on a pre-determined criteria. Typically, before the user 125 can receive the virtual mobile coupons from the server 110, the user 125 has to register with the coupon service using either the wireless device 115 or any other trusted medium. The pre-determined criteria may be evaluated based on one or more of a group comprising location of the wireless device 115, location of the user 125, purchase history of the user 125, redemption history of the user 125, profile of the user 125 and social activity of the user 125.

Each virtual mobile coupon is generated based on a set of coupon parameters provided by a client 130. In an embodiment, the virtual mobile coupon is associated with a unique user identifier. In another embodiment, the virtual mobile coupon is associated with the registered client's identifier. The client 130 is one of a merchant and a manufacturer. Typically, a merchant is a seller, distributor, re-seller, wholesale seller, broker, or any other intermediary between a manufacture and a customer. In an embodiment, the merchant or manufacturer will register with the coupon service running on the server 110. In an example, if a virtual mobile coupon is to be shared with the user 125 of the wireless device 115, the coupon service associates that virtual mobile coupon with a unique identifier of the user 125.

In an embodiment of the present invention, the wireless device 115 includes a processor configured for receiving, managing, redistributing and redeeming the virtual mobile coupons. Typically, the processor of the wireless device 115 executes a software application that manages receiving, redistributing and redeeming of the virtual mobile coupons. In an example, a first user receives a virtual mobile coupon on his wireless device from the coupon service. The mobile application running on the wireless device of the first user receives the virtual mobile coupon, displays the virtual mobile coupon on the display screen of the wireless device and also, enables the first user to redistribute/share the virtual mobile coupon with a second user. The second user may belong to a trusted network of the first user. For example, the second user may be a social connection of the first user on a social networking website or in a messaging application. Examples of the social networking website and messaging applications include, but not limited to, Facebook®, Twitter®, LinkedIn®, MySpace®, Google+®, Tumblr®, YouTube®, Instagram®, SnapChat®, WhatsApp®, Viber®, Line®, Youku®, Weibo® and Renren®.

In an embodiment of the present invention, the mobile application running on the wireless device 115 enables the user 125 to automatically redeem the virtual mobile coupons. In this embodiment, the wireless device 115 includes a mobile tracking unit that detects a merchant site 135 when the wireless device 115 is in proximity of a Point-Of-Sale (POS) 140. The wireless device 115 identifies a set of virtual mobile coupons redeemable at the POS 140 and automatically, sends the set of virtual mobile coupons to the POS 140 for redemption. In an embodiment of the present invention, the wireless device 115 may communicate with the POS 140 using the Near-Field-Communication (NFC) technology.

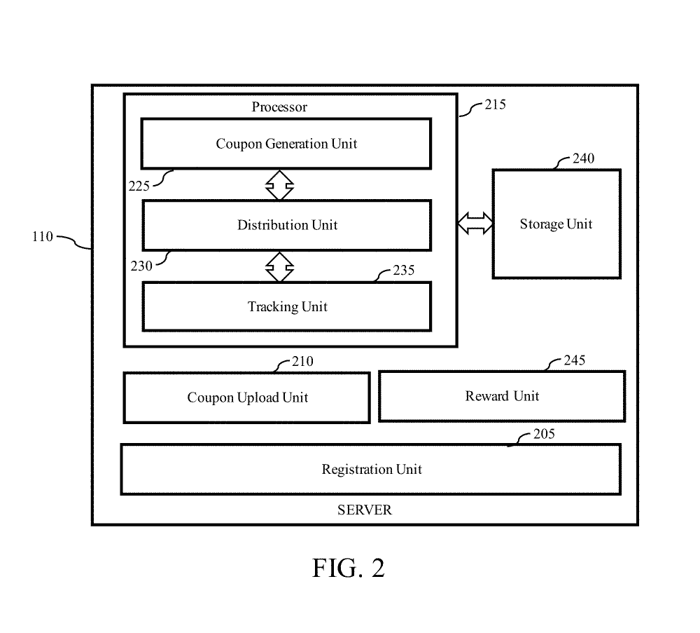

FIG. 2 illustrates an exemplary server 110 for generating, managing and redeeming virtual mobile coupons according to an embodiment of the invention. Typically, the server 110 executes the coupon service utilizing the system components shown in FIG. 2.

In an embodiment of the present invention, the server 110 includes a registration unit 205 and a coupon upload unit 210. Before the client 130, who may be a merchant or a manufacturer, may use the coupon service to distribute one or more coupons, the client 130 has to register with the coupon service. The client 130 accesses the coupon service through a communication network such as the Internet. The registration unit 205 provides a registration interface to the client 130. Once the required information is provided by the client 130, the registration unit 205 assigns a unique identifier to the client 130. The registration unit 205 also generates and stores a profile for the client 130 and updates the profile regularly. Examples of the information required for registration may include, but is not limited to, name of the organization, date of incorporation, type of business, size of the organization and contact details of the organization.

In an embodiment of the present invention, the registration unit 205 also maintains a profile for each of the users registered with the coupon service, example of the user being the user 125. In an embodiment, profile for the user 125 includes one or more of a phone number, gender, age, interests and hobbies, address, marital status, residence, and other information related to the user 125.

The coupon upload interface 210 provides an interface to the client 130 registered with the coupon service. While using the interface for uploading a retail coupon, the client 130 provides a set of coupon parameters. The set of coupon parameters includes one or more of the group comprising a unique identifier of the client 130, a coupon identifier, a distribution channel, payment methods for redeeming the coupons, validity of the coupon, type of coupon (such as promotional, rebate, freebies, shipping discount, clearance and sale), discount rate, number of times the coupon can be redeemed, redemption method for the coupon (such as online, offline, QR code or NFC), category of the coupon, if the coupon can be shared among users, printability of the coupon and geographic limitation on coupon redemption/distribution. In an embodiment of the present invention, the client 130 may provide the set of coupon parameters using a file upload option provided by the coupon upload interface 210.

The server 110 also includes a processor 215 communicatively coupled with a storage unit 220. The processor includes a coupon generation unit 225, a distribution unit 230 and a tracking unit 235.

Typically, the coupon generation unit 225 generates a virtual mobile coupon based on the set of coupon parameters provided by the client 130. The set of coupon parameters is encrypted to generate a coupon code. The coupon generation unit 225 further assigns a unique user identifier to the coupon code to generate a virtual mobile coupon.

In an embodiment of the present invention, the virtual mobile coupon generated by the coupon generation unit 225 is a level 1 virtual mobile coupon. The level 1 virtual mobile coupon is distributed by the distribution unit 230 to one or more users based on the pre-determined criteria. For example, a level 1 virtual mobile coupon is distributed to the user 125 of the wireless device 115, when the user 125 enters a particular merchant site. For example, the user 125 enters a Traget® or a Walmart® store. In another example, a level 1 virtual mobile coupon related to sports equipment is distributed to the user 125 of the wireless device 115, if the server 110 identifies that the user 125 is a football fan based on his profile registered with the coupon service.

In an embodiment, the coupon generation unit 225 generates a level two virtual mobile coupon when the user 125 redistributes the level 1 virtual mobile coupon to another user. The level two virtual mobile coupon is generated by associating the unique user identifier of the other user with the coupon code of the level 1 virtual mobile coupon. For example, a first user receives a level 1 virtual mobile coupon from the coupon service. When the first user redistributes the level 1 virtual mobile coupon to a second user, the coupon generation unit 225 generates a level two virtual mobile coupon by associating the unique user identifier of the second user with the coupon code of the level 1 virtual mobile coupon. Further, in case the second user redistributes the level two virtual mobile coupon to a third user, the coupon generation unit 225 generates a level 3 virtual mobile coupon by associating the unique user identifier of the third user with the coupon code of the level 1 virtual mobile coupon. In an embodiment, additional levels of virtual mobile coupons (level 4, level 5 etc.) may also be generated by subsequent redistribution.

The tracking unit 235 tracks the redistribution and redemption of the virtual mobile coupons. In an example, when the level 1 virtual mobile coupon is redistributed by the first user to the second user, the tracking unit 235 determines the unique user identifier of the second user. In an embodiment, the tracking unit tracks the number of times a virtual mobile coupon is redistributed and redeemed. Also, when a user, for example the user 125 redeems the virtual mobile coupon, the tracking unit 235 records a redemption status comprising at least one of the group comprising the unique user identifier of the user 125, coupon code of the virtual mobile coupon, a timestamp, an identifier of a Point-of-Sale (POS) of redemption, a merchant identifier and a manufacturer identifier.

In an embodiment, the tracking unit 235 also tracks at least one of the group comprising location of the users, visits to merchant sites by the users, purchase history of the users, redemption history of the users, unsuccessful attempts at redemption by the users and social activity of the users.

The information tracked by the tracking unit 235 may be anonymously provided to one or more clients. In an embodiment, the tracked information is used by the distribution unit 230 to selectively distribute virtual mobile coupons to users.

The server 110 stores coupon metadata of the virtual mobile coupons in the storage unit 240. Coupon metadata for a virtual mobile coupon comprises the set of coupon parameters provided by the client 130 and a unique user identifier, an example being the unique user identifier of the user 125. The redemption status and other tracking information recorded by the tracking unit 235 are also stored in the storage unit 240. In an embodiment, the information provided by the client 130 and the user 125 during registration is also stored in the storage unit 240.

In an embodiment of the present invention, the server 110 also includes a reward unit 245. The reward unit 245 awards reward points to the users based on a rewarding criteria. Examples of the reward points include, but are not limited to, discount offers, gift cards, rebates, paybacks, money and credit points. The rewarding criteria is determined by the client 130 and is based on the information tracked by the tracking unit 235. For example, a user may be awarded a certain number of award points, if the user redistributes a virtual mobile coupon to more than ten other users. In another example, the user may be awarded, if the rate of redemption for the user is above a threshold defined by the client 130.

Typically, the rewarding criteria for awarding the user 125 is based on one or more of the group comprising number of times a virtual mobile coupon is redistributed by the user 125, number of times a virtual mobile coupon is redeemed by the user 125, number of visits to merchant sites or redemption stores by the user 125, and duration of the visits to the merchant sites or redemption stores by the user 125.

In another embodiment of the present invention, the rewarding criteria for awarding the user are also based on the activities of the social connections of the user. For example, a user, such as the user 125 may redistribute a virtual mobile coupon to ten of his social connections. Still, the user may not get any award points if none of the social connections redeem the virtual mobile coupon. Therefore, the rewarding criteria for awarding the user is also based on one or more of the group comprising redistribution of the virtual mobile coupon by the social connections of the user, redemption of the virtual mobile coupon by the social connections of the user, visits to merchant sites by the social connections of the user and duration of the visits to merchant sites by the social connections of the user.

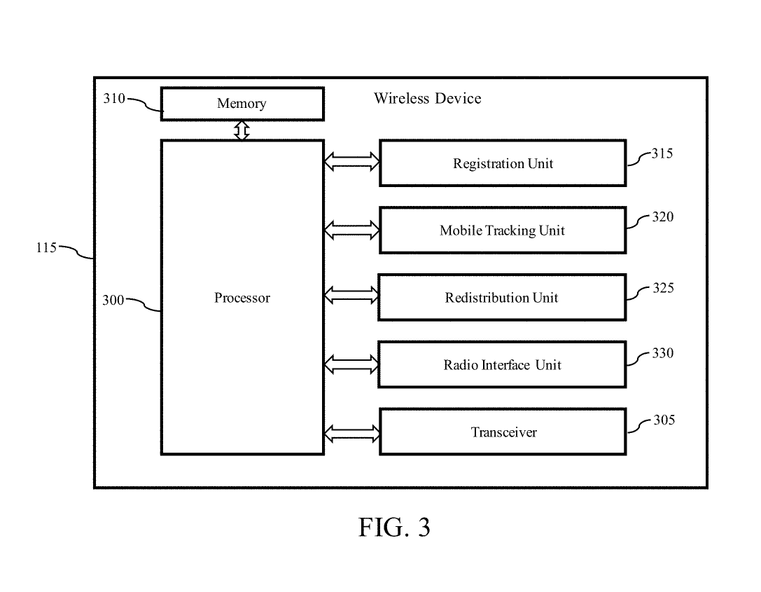

FIG. 3 is a bock diagram illustrating the wireless device 115 for managing and redeeming virtual mobile coupons according to an embodiment of the invention. Typically, the wireless device 115 is a smartphone. The wireless device 115 includes a processor 300, a transceiver 305 and a memory 310. The processor 300 is operatively coupled to the transceiver 305 and the memory 310. In an embodiment, the transceiver 305 receives a virtual mobile coupon from the coupon service and stores the virtual mobile coupon in the memory 310.

In an embodiment, to be able to receive and access virtual mobile coupons on the wireless device 115, the user 125 installs a mobile coupon application on the wireless device 115. The mobile coupon application running on the processor 300 enables the user 125 to receive, view, manage, redistribute and redeem the virtual mobile coupons.

The wireless device 115 also includes a registration unit 315, a mobile tracking unit 320, a redistribution unit 325 and a radio interface unit 330. The user 125 registers with the coupon service using the registration unit 315. The coupon service generates a profile and associates the profile with a mobile phone number of the user 125. The profile may further include name, gender, age, social connections and hobbies/interests of the user 125. In an embodiment, the user 125 may login to the mobile coupon application using at least one of the mobile phone number, an email account or a social network account of the user 125. An example of the social network account is the Facebook® account.

The mobile tracking unit 320 tracks activities of the user 125. In an example, the mobile tracking unit 320 includes a location determination unit, such as a Global Positioning System (GPS) unit that tracks the current location of the user 125. Further, based on the current location, the mobile tracking unit 320 is configured to detect if the user 125 is at a merchant site or is in proximity of a point-of-sale (POS) terminal.

In another example, the mobile tracking unit 320 tracks attempts to redeem a coupon by the user 125. In case, a virtual mobile coupon is successfully redeemed, the mobile tracking unit 320 records at least one of the unique user identifier of the user 125, coupon code of the virtual mobile coupon, a timestamp, an identifier of a Point-of-Sale (POS) of redemption, a merchant identifier and a manufacturer identifier.

The redistribution unit 325 enables the user 125 to redistribute virtual mobile coupons. The user 125 may share a virtual mobile coupon with another user through a communication medium. Examples of the communication medium include, but are not limited to email, social networks, mobile phone messages and web-based mobile messaging applications. In an embodiment, the user 125 logs-in the mobile coupon application to retrieve a list of virtual mobile coupons stored in the memory 310. Further, the user 125 may select one or more virtual mobile coupons to be redistributed to the other user. In this example, the mobile tracking unit 320 records a unique user identifier associated with the other user.

The radio interface unit 330 is a transceiver that enables communication between the wireless device 115 and another entity when the wireless device 115 and the other entity are either in contact or in close proximity. Examples of the radio interface unit include, but are not limited to, a Near Field Communication (NFC) transceiver/interface (ISO/IEC 18092/ECMA-340 or ISO/IEC 21481/ECMA-352) and a Bluetooth (IEEE 802.15.1) transceiver. Near-field communication is a technology that enables the wireless device 115 to communicate with the POS terminal 140 through a radio channel when either the wireless device 115 touches the POS terminal 140 or is brought in proximity of the POS 140. There are two major standards for NFC. First, ISO/IEC 18092/ECMA-340 Near Field Communication Interface And Protocol-1 (NFCIP-1) and second, ISO/IEC 21481/ECMA-352 and Near Field Communication Interface And Protocol-2 (NFCIP-2). NFC standards specify the modulation schemes, coding, transfer speeds and frame format of the RF interface of NFC devices, as well as initialization schemes and conditions required for data collision-control during initialization for both passive and active NFC modes. Furthermore, they also define the transport protocol, including protocol activation and data-exchange methods.

In an embodiment, the radio interface unit 330 communicates with the Point-Of-Sale (POS) terminal 140 when the user 125 is at the merchant site 135. In an embodiment, the wireless device 115 receives a list of products the user 125 wants to purchase from the POS (140).

In an embodiment, when the wireless device 115 is in proximity of the POS 140, the processor identifies a set of virtual mobile coupons that are redeemable at the POS 140. Further, the set of redeemable virtual mobile coupons is automatically sent to the POS 140 through the radio interface unit 330.

In an embodiment, the mobile coupon application allows the user 125 to define a set of rules for automatically redistributing a virtual mobile coupon. For example, a user may be directly connect to another user through Facebook® wherein the second user is a musician. In this example, using the mobile coupon application, the user may define a rule, for automatically sharing all virtual mobile coupons related to musical instruments with the second user via Facebook®.

In an embodiment, the mobile coupon application running on the processor 300 allows the user 125 to set priorities among the plurality of virtual mobile coupons based on a pre-determined priority criteria. The pre-determined priority criteria may be based on at least one of expiry, validity, rate of discount, merchant and manufacturer associated with the virtual mobile coupons. For example, a user receives a virtual mobile coupon of a merchant from a first user. The user then receives another virtual mobile coupon of the same merchant from a second user. In this case, the user may set the pre-determined priority criteria in such a manner that the virtual mobile coupon with the shorter validity is redeemed first. In an embodiment, the wireless device 115 generates a Quick Response Code (QR code) for the virtual mobile coupon.

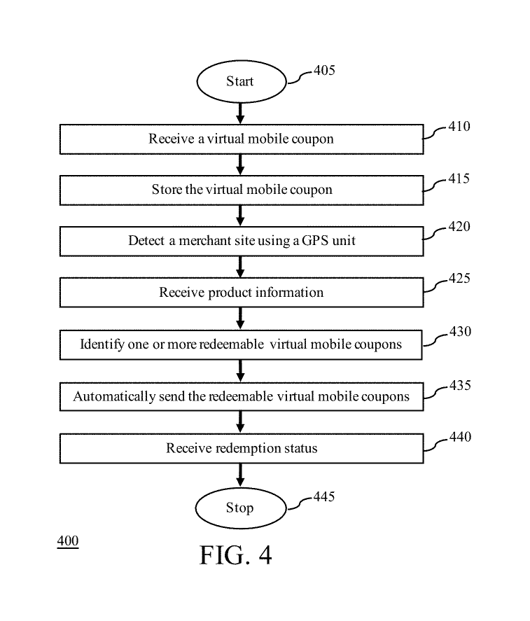

FIG. 4 illustrates a method 400 for redeeming virtual mobile coupons according to an embodiment of the invention. The method for redeeming a virtual mobile coupon starts at step 405.

At step 410, the wireless device 115 receives a virtual mobile coupon from the server 110 through the network 120. Typically, the virtual mobile coupon is received by the transceiver 305.

At step 415, the wireless device 115 stores the virtual mobile coupon in the memory unit 310 so that the virtual mobile can be retrieved for redemption subsequently.

At step 420, the wireless device 115 detects the merchant site 135 using the mobile tracking unit 320. For example, when the user 125 enters the premises of the merchant site 135, the mobile tracking unit 320 identifies the merchant associated with the merchant site 135. In another example, the mobile tracking unit 320 identifies the merchant when the wireless device 115 is in proximity of the POS 140. In an embodiment, the user 125 may be allowed to manually select the merchant from a list of merchants provided by the mobile coupon application.

At step 425, the wireless device 115 receives product information from the POS 140. The product information may include a list of items that user 125 desires to purchase or are present in the shopping cart of the user 125.

At step 430, the processor 300 of the wireless device 115 identifies one or more virtual mobile coupons redeemable at the POS 140. The redeemable virtual mobile coupons are identified based on either the merchant identified at the step 420 or the product information received at the step 425. In an embodiment, the user 125 may select the virtual mobile coupons to be redeemed at the POS 140 from the list of virtual mobile coupons stored in the memory 310. The user 125 uses the mobile coupon application to select the virtual mobile coupons for redemption.

At step 435, the wireless device 115 automatically sends the one or more virtual mobile coupons redeemable at the POS 140 through the radio interface unit 330 to the POS 140.

At step 440, the wireless device 115 receives the redemption status from the POS 140 through the radio interface unit 330. The redemption status may include one or more of an indicator that determines if a virtual mobile coupon could be successfully redeemed, an electronic receipt of the purchase, product information, a redemption value and a merchant identifier.

In an embodiment, the wireless device 115 generates a QR code for a virtual mobile coupon that the user 125 desires to redeem. This is required when the POS 140 does not include the hardware required to communicate with the radio interface unit 330. The QR code may be scanned by the POS 140 for redeeming the virtual mobile coupon. In an embodiment, the QR code is displayed at the display screen of the wireless device 115. Thereafter, the method 400 terminates at step 445.

The invention further relates to a non-transitory computer-readable medium storing instructions for providing a coupon management system. The instructions are executed on the processor to cause the processor 300 to receive a plurality of virtual mobile coupons, store the plurality of virtual mobile coupons in a memory 310, detect a merchant site using a mobile tracking unit 320, identify one or more virtual mobile coupons of the plurality of virtual mobile coupons that are redeemable at a POS and automatically send one or more virtual mobile coupons to the POS using a radio interface unit 310 for redemption.

In an embodiment, the processor receives product information through the radio interface unit 310 from the POS.

In an embodiment, the processor enables a user to manually select one or more virtual mobile coupons to be sent to the POS for redemption.

In an embodiment, the processor receives a redemption status from the POS.

In the foregoing specification, the invention and its benefits and advantages have been described with reference to specific embodiments. However, one with ordinary skill in the art would appreciate that various modifications and changes can be made without departing from the scope of the present invention, as set forth in the claims. Accordingly, the specification and the figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A system for generating, managing and redeeming a plurality of virtual mobile coupons, the system comprising:
a processor comprising:
a coupon generation unit configured to generate a plurality of virtual mobile coupons, wherein a virtual mobile coupon is generated based on a set of coupon parameters provided by a registered client, and wherein the virtual mobile coupon is associated with a unique user identifier;
a distribution unit configured to distribute the virtual mobile coupon to one or more users based on a pre-determined criteria, wherein a first user of the one or more users receives the virtual mobile coupon using a wireless device, and wherein the wireless device enables the first user to redistribute the virtual mobile coupon to a second user; and
a tracking unit configured to track at least one of the redistribution of the virtual mobile coupon and redemption of the virtual mobile coupon, wherein when the virtual mobile coupon is redistributed by the first user to the second user, the tracking unit records a unique user identifier of the of the second user; and
a storage unit communicably coupled to the processor, the storage unit configured to:
store a coupon metadata for the virtual mobile coupon, the coupon metadata being generated by the processor, wherein the coupon metadata comprises at least the set of coupon parameters and the unique user identifier associated the virtual mobile coupon; and
store a redemption status for the virtual mobile coupon.

2. The system according to claim 1, wherein the registered client is at least one of a merchant and a manufacturer.

3. The system according to claim 1 further provides a coupon upload interface, wherein the registered client uses the coupon upload interface to provide the set of coupon parameters.

4. The system according to claim 1, wherein the coupon generation unit is further configured to generate a level two virtual mobile coupon, the level two virtual mobile coupon is generated to redistribute a level one virtual mobile coupon to the second user, wherein the level two virtual mobile coupon is redistributed by the first user to the second user.

5. The system according to claim 1, wherein the second user belongs of a trusted social network of the first user.

6. The system according to claim 1, wherein the tracking unit is further configured to track redistribution of the virtual mobile coupon.

7. The system according to claim 1, wherein the pre-determined criteria is at least one of location of a user, a purchase history of the user, a redemption history of the user, a profile associated with the user and a social activity of the user.

8. The system according to claim 1, wherein the system further comprises a reward unit configured to award reward points to the first user based on a rewarding criteria.

9. The system according to claim 8, wherein the rewarding criteria is determined based on at least one of number of times the virtual coupon is redistributed, number of times the virtual mobile coupon is redeemed, visits to redemption stores by at least one of the first user and the second user.

10. The system according to claim 1, wherein the redemption status of the virtual mobile coupon comprises at least one of a unique user identifier, a timestamp, an identifier of a Point-of-Sale (POS), a merchant identifier and a manufacturer identifier.

11. A wireless device for managing and redeeming virtual mobile coupons, the wireless device comprising:
a registration unit configured to register a user with a coupon service;
a transceiver configured to receive a plurality of virtual mobile coupons from the coupon service, wherein the plurality of virtual mobile coupons is stored in a memory unit;
a redistribution unit configured to redistribute a virtual mobile coupon of the plurality of virtual mobile coupons;
a mobile tracking unit configured to detect a merchant site, wherein the wireless device detects the merchant site when the wireless device is proximate to a point-of-sale (POS);
a radio interface unit configured to communicate with the POS, wherein the radio interface unit receives product information from the POS;
a processor configured to identify one or more virtual mobile coupons of the plurality of virtual mobile coupons, wherein the one or more virtual mobile coupons are redeemable at the POS; and
the radio interface unit further configured to automatically send the one or more virtual mobile coupons to the POS, wherein the one or more virtual mobile coupons are sent to the POS for redemption.

12. The wireless device according to claim 11, wherein the radio interface unit is a Near Field Communication (NFC) interface.

11. wireless device according to claim 11, wherein the redistribution unit is further configured to define a set of rules for automatically redistributing the virtual mobile coupon.

14. The wireless device according to claim 11, wherein the processor is further configured to set priorities among the plurality of virtual mobile coupons based on a pre-determined priority criteria.

15. The wireless device according to claim 11, wherein the processor is further configured to generate a Quick Response Code (QR code) for the virtual mobile coupon.

16. The wireless device according to claim 11, wherein the mobile tracking unit is further configured to record at least one of from the group comprising purchase history of the user, redemption history of the user, and visits to one or more merchant sites by the user.

17. A non-transitory computer-readable medium storing instructions for providing a coupon management system, the instructions when executed on a processor causes the processor to:
receive a plurality of virtual mobile coupons wherein, each virtual mobile coupon of the plurality of virtual mobile coupons is associated with a registered client;
store the plurality of virtual mobile coupons in a memory unit;
detect a merchant site using a mobile tracking unit, wherein the processor detects the merchant site when the processor is proximate to a point-of-sale (POS);
identify one or more virtual mobile coupons of the plurality of virtual mobile coupons, wherein the one or more virtual mobile coupons are redeemable at the POS; and
automatically send the one or more virtual mobile coupons to the POS using a radio interface unit, wherein the one or more virtual mobile coupons are sent to the POS for redemption.

18. The non-transitory computer-readable medium according to claim 17, wherein the processor receives product information through the radio interface unit from the POS.

19. The non-transitory computer-readable medium according to claim 17, wherein the processor enables a user to manually select one or more virtual mobile coupons to be sent to the POS for redemption.

17. non-transitory computer-readable medium according to claim 17, wherein the processor receives a redemption status from the POS.
